(19) United States
(12) Patent Application Publication
(10) Pub. No.: US 2009/0040434 A1
(43) Pub. Date: Feb. 12, 2009

(54) Method of producing elliptically polarizing plate and image display apparatus using the elliptically polarizing plate

(75) Inventors: Ikuo Kawamoto, Osaka (JP); Seiji Umemoto, Osaka (JP); Takashi Kamijou, Osaka (JP); Hideyuki Yonezawa, Osaka (JP); Kazuya Hada, Osaka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: Nitto Denko Corporation, Osaka (JP)

(21) Appl. No.: 10/581,724

(22) PCT Filed: Dec. 8, 2005
(86) PCT No.: PCT/JP05/22538

§ 371 Date: Sep. 18, 2008

(30) Foreign Application Priority Data
Feb. 25, 2005 (JP) 2005-049924

(51) Int. Cl. G02F 1/13363; B29D 11/00

(52) U.S. Cl. 349/96; 156/99; 349/194

(57) ABSTRACT

To provide a method of producing a broadband and wide viewing angle elliptically polarizing plate having excellent properties in an oblique direction, the elliptically polarizing plate, and an image display apparatus.

The method of producing an elliptically polarizing plate of the present invention includes the steps of: forming a first birefringent layer on a surface of a transparent protective film; laminating a polarizer on a surface of the transparent protective film; and forming a second birefringent layer on a surface of the first birefringent layer, in which: the first birefringent layer and the polarizer are arranged on opposite sides of the transparent protective film; the step of forming a first birefringent layer includes the steps of: applying a liquid crystal material to an alignment substrate; forming a first birefringent layer on the substrate from the liquid crystal material; and transferring the first birefringent layer to a surface of the transparent protective film; and angles α and β satisfy a predetermined relationship (where, α represents an angle formed between a slow axis of the polarizer and a slow axis of the first birefringent layer, and β represents an angle formed between the absorption axis of the polarizer and a slow axis of the second birefringent layer).

### TECHNICAL FIELD

The present invention relates to an elliptically polarizing plate, and to an image display apparatus using the same. The present invention more specifically relates to a method of producing a broadband and wide viewing angle elliptically polarizing plate having excellent characteristics in an oblique direction as well at very high production efficiency, to an elliptically polarizing plate obtained through the method, and to an image display apparatus using the elliptically polarizing plate.

### BACKGROUND ART

Various optical films each having a polarizing film and a retardation plate in combination are generally used for various image display apparatuses such as a liquid crystal display apparatus and an electroluminescence (EL) display, to thereby obtain optical compensation.

In general, a circularly polarizing plate which is one type of optical films can be produced by combining a polarizing film and a λ/4 plate. However, the λ/4 plate has characteristics providing larger retardation values with shorter wavelengths, so-called “positive wavelength dispersion characteristics”, and the λ/4 plate generally has high positive wavelength dispersion characteristics. Thus, the λ/4 plate has a problem in that it cannot exhibit desired optical characteristics (such as functions of the λ/4 plate) over a wide wavelength range. In order to avoid the problem, there has been recently proposed a retardation plate having wavelength dispersion characteristics providing larger retardation values with longer wavelengths, so-called “reverse dispersion characteristics” such as a norbornene-based film and a modified polycarbonate-based film. However, such a film has problems in cost.

At present, a λ/4 plate having positive wavelength dispersion characteristics is combined with, for example, a retardation plate providing larger retardation values with longer wavelengths or a λ/2 plate, to thereby correct the wavelength dispersion characteristics of the λ/4 plate (see JP 3174367 B, for example)

In a case where a polarizing film, a λ/4 plate, and a λ/2 are combined as described above, angles of respective optical axes, that is, angles between an absorption axis of the polarizing film and slow axes of the respective retardation plates must be adjusted. However, the optical axes of the polarizing film and the retardation plates each formed of a stretched film generally vary depending on stretching directions. The respective films must be cut out in accordance with directions of the respective optical axes and laminated, to thereby laminate the films such that the absorption axis and the slow axes are at desired angles. To be specific, an absorption axis of a polarizing film is generally in parallel with its stretching direction, and a slow axis of a retardation plate is also in parallel with its stretching direction. Thus, for lamination of the polarizing film and the retardation plate at an angle between the absorption axis and the slow axis of 45°, for example, one of the films must be cut out in a direction of 45° with respect to a longitudinal direction (stretching direction) of the film. In the case where a film is cut out and then attached as described above, angles between optical axes may vary by cut-out film, for example. The variation may result in problems of variation in quality by product and production requiring high cost and long time. Further problems include increased waste by cutting out of the films, and difficulties in production of large films.

As a countermeasure to the problems, there is proposed a method of adjusting a stretching direction by stretching a polarizing film or a retardation plate in an oblique direction or the like (see JP 2003-195037 A, for example). However, the method has a problem in that the adjustment involves difficulties.

Further, at present, an angle between an absorption axis of a polarizing film and a slow axis of each retardation plate is adjusted by product, and comprehensive means for optimization of the angle has not been found yet.

### DISCLOSURE OF THE INVENTION

### Problems to be Solved by the Invention

The present invention has been made in view of solving the conventional problems as described above, and an object of the present invention is therefore to provide: a method of producing a broadband and wide viewing angle elliptically polarizing plate having excellent characteristics in an oblique direction as well at very high production efficiency; an elliptically polarizing plate obtained through the method; and an image display apparatus using the elliptically polarizing plate.

### Means for Solving the Problems

The inventors of the present invention have conducted intensive studies on a relationship among an absorption axis of a polarizer and slow axes of a λ/4 plate and a λ/2 plate, and have found that excellent broadband and wide viewing angle characteristics can be obtained when angle between the absorption axis and the respective slow axes are in a specific relationship, to thereby complete the present invention.

A method of producing an elliptically polarizing plate of the present invention includes the steps of: forming a first birefringent layer on a surface of a transparent protective film (T); laminating a polarizer on a surface of the transparent protective film (T); and forming a second birefringent layer by laminating a polymer film on a surface of the first birefringent layer, in which: the first birefringent layer and the polarizer are arranged on opposite sides of the transparent protective film (T); the step of forming a first birefringent layer includes the steps of: applying an application liquid containing a liquid crystal material to a substrate subjected to alignment treatment; forming a first birefringent layer on the substrate by treating the applied liquid crystal material at a temperature at which the liquid crystal material exhibits a liquid crystal phase; and transferring the first birefringent layer formed on the substrate to a surface of the transparent protective film (T); and angles α and β satisfy a relationship represented by the following expression (1):

2α+40°<β<2α+50° (1)

where, α represents an angle formed between a slow axis of the polarizer and a slow axis of the first birefringent layer, and β represents an angle formed between the absorption axis of the polarizer and a slow axis of the second birefringent layer.

In a preferred embodiment: the polarizer, the transparent protective film (T), the first birefringent layer formed on the substrate, and the polymer film used for forming the second birefringent layer are each a continuous film; long sides of the polarizer, the transparent protective film (T), and the first birefringent layer formed on the substrate are continuously attached together to form a laminate including the polarizer, the transparent protective film (T), the first birefringent layer, and the substrate in the stated order; the substrate is peeled off from the laminate; and long sides of the laminate having the substrate peeled off and the polymer film used for forming the second birefringent layer are continuously attached together.

In a preferred embodiment, the liquid crystal material includes at least one of a liquid crystal monomer and a liquid crystal polymer.

In a preferred embodiment, the first birefringent layer is a λ/2 plate.

In a preferred embodiment, the second birefringent layer is a λ/4 plate.

In a preferred embodiment, the substrate is a polyethylene terephthalate film.

In a preferred embodiment, the polymer film is a stretched film.

Another aspect of the present invention provides an elliptically polarizing plate. The elliptically polarizing plate is produced through the above-mentioned production method.

Further, the other aspect of the present invention provides an image display apparatus. This image display apparatus includes the above-mentioned elliptically polarizing plate.

### EFFECT OF THE INVENTION

As described above, according to the present invention, the slow axis of the first birefringent layer can be set in an arbitrary direction in the alignment treatment for the substrate, and thus a continuous polarizing film (polarizer) stretched in a longitudinal direction (that is, a film having an absorption axis in a longitudinal direction) can be used. In other words, a continuous first birefringent layer formed on the substrate which is subjected to the alignment treatment to be at a predetermined angle with respect to its longitudinal direction, a continuous transparent protective film, and a continuous polarizing film (polarizer) may be continuously attached together with the respective longitudinal directions in the same direction (by so-called roll to roll). Thus, an elliptically polarizing plate can be obtained at very high production efficiency. According to the method of the present invention, the film need not be cut out obliquely with respect to its longitudinal direction (stretching direction) for lamination. As a result, angles of optical axes do not vary by cut-out film, resulting in an elliptically polarizing film without variation in quality by product. Further, no wastes are produced by cutting of the film, and the elliptically polarizing plate can be obtained at low cost and production of a large polarizing plate is facilitated. Meanwhile, a substrate is peeled off from a laminate having a polarizer, a transparent protective film, a first birefringent layer, and the substrate in the stated order. A polymer film stretched in a width direction and having a slow axis in the width direction is used as the polymer film forming the second birefringent layer. Thus, long sides of the laminate from which the substrate is peeled off and the polymer film may be continuously attached together, and an elliptically polarizing plate can be obtained at very high production efficiency. Further, such the production method is employed to thereby provide an elliptically polarizing plate having excellent adhesiveness between films (layers). The thus-obtained elliptically polarizing plate is optimized to have angles α and β in a relationship represented by an expression 2α+40°<β<2α+50° (wherein, α represents an angle between an absorption axis of the polarizer and the slow axis of the first birefringent layer (λ/2 plate), and β represents an angle between the absorption axis of the polarizer and the slow axis of the second birefringent layer (λ/4 plate)), to thereby provide an image display apparatus with broadband and wide viewing angle. The relationship is comprehensive, and requires no studies on lamination direction depending on products by trial and error. That is, the relationship may be used for almost all combinations of the polarizer, λ/2 plate, and λ/4 plate, to thereby realize excellent circular polarization characteristics. As a result, optimization of the circular polarization characteristics can be extremely generalized and facilitated.

### BRIEF DESCRIPTION OF THE DRAWINGS

FIG. 1 is a schematic sectional view of an elliptically polarizing plate according to a preferred embodiment of the present invention.

FIG. 2 is an exploded perspective view of an elliptically polarizing plate according to the preferred embodiment of the present invention.

FIG. 3 is a perspective view showing an outline of a step in the example of a method of producing an elliptically polarizing plate according to the present invention.

FIG. 4 are perspective views showing outlines of another step in the example of a method of producing an elliptically polarizing plate according to the present invention.

FIG. 5 are schematic views showing an outline of still another step in the example of a method of producing an elliptically polarizing plate according to the present invention.

FIG. 6 is a schematic view showing yet another step in the example of a method of producing an elliptically polarizing plate according to the present invention.

FIG. 7 are schematic views showing an outline of still yet another step in the example of a method of producing an elliptically polarizing plate according to the present invention.

FIG. 8 are schematic views showing another step in the example of a method of producing an elliptically polarizing plate according to the present invention.

FIG. 9 is a schematic sectional view of a liquid crystal panel used for a liquid crystal display apparatus according to the preferred embodiment of the present invention.

### DESCRIPTION OF SYMBOLS

10 Elliptically polarizing plate
11 Polarizer
12 First birefringent layer
13 Second birefringent layer
14 First protective layer
15 Second protective layer
20 Liquid crystal cell
100 Liquid crystal panel

### BEST MODE FOR CARRYING OUT THE INVENTION

### A. Elliptically Polarizing Plate

### A-1. Entire Constitution of Elliptically Polarizing Plate

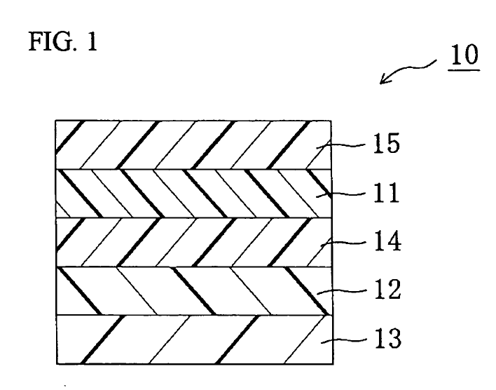

FIG. 1 shows a schematic sectional view of an elliptically polarizing plate according to a preferred embodiment of the present invention. An elliptically polarizing plate 10 includes a polarizer 11, a first birefringent layer 12, and a second birefringent layer 13. As required, a first protective layer (transparent protective film) 14 is provided between the polarizer 11 and the first birefringent layer 12, and a second protective layer 15 is provided on the opposite side of the first protective layer 14 of the polarizer.

The first birefringent layer 12 may serve as a so-called λ/2 plate. In the specification of the present invention, the λ/2 plate refers to a plate having a function of converting linearly polarized light having a specific vibration direction into linearly polarized light having a vibration direction perpendicular thereto, or converting right-handed circularly polarized light into left-handed circularly polarized light (or converting left-handed circularly polarized light into right-handed circularly polarized light). The second birefringent layer 13 may serve as a so-called λ/4 plate. In the specification of the present invention, the λ/4 plate refers to a plate having a function of converting linearly polarized light having a specific wavelength into circularly polarized light (or converting circularly polarized light into linearly polarized light).

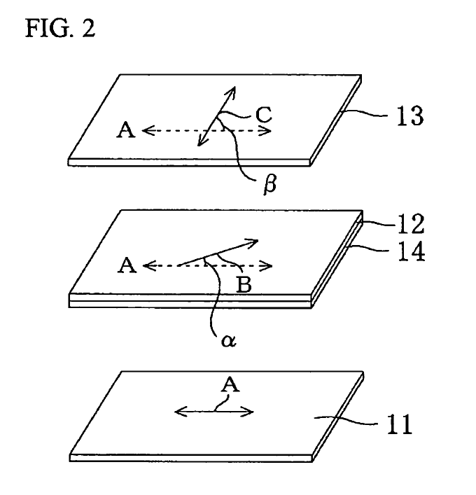

FIG. 2 is an exploded perspective view explaining optical axes of respective layers constituting an elliptically polarizing plate according to the preferred embodiment of the present invention (In FIG. 2, the second protective layer 15 is omitted for clarity). The first birefringent layer 12 is laminated such that its slow axis B is defined at a predetermined angle α with respect to an absorption axis A of the polarizer 11. The second birefringent layer 13 is laminated such that its slow axis C is defined at a predetermined angle β with respect to the absorption axis A of the polarizer 11. The slow axis is in a direction providing a maximum in-plane index of refraction.

In the present invention, the angles α and β are in a relationship represented by the following expression (1).

2α+40°<β<2α+50° (1)

The relationship between the angles α and β is more preferably 2α+42°<β<2α+48°, more preferably 2α+43°<β<2α+47°, and most preferably β=2α+45°. The angles α and β in such a relationship provides a polarizing plate having excellent circular polarization characteristics. In addition, the relationship is comprehensive, and requires no studies on lamination direction depending on products by trial and error. That is, the relationship may be used for almost all combinations of the polarizer, λ/2 plate, and λ/4 plate, to thereby realize excellent circular polarization characteristics. Finding of such a relationship is a feature of the present invention, and is a very useful accomplishment in a technical field relating to optimization of circular polarization characteristics.

The angle α is preferably +8° to +38° or −8° to −38°, more preferably +13° to +33° or −13° to −33°, particularly preferably +19° to +29° or −19° to −29°, especially preferably +21° to +27° or −21° to −27°, and most preferably +23° to +24° or −23° to −24°. Thus, in the most preferred embodiment (β=2α+45°) of the present invention, the angle β is preferably +61° to +121° or −31° to +29°, more preferably +71° to +111° or −21° to +19°, particularly preferably +83° to +103° or −13° to +7°, especially preferably +87° to +99° or −9° to +3°, and most preferably +91° to +93° or −3° to −1°. In consideration of a production procedure for an elliptically polarizing plate (described below), it is particularly preferred that the angle β be substantially in parallel with or substantially perpendicular to the absorption axis of the polarizer. In the specification of the present invention, the phrase “substantially parallel” includes a case at 0°±3.0°, preferably 0°±1.0°, and more preferably 0°±0.5°. The phrase “substantially perpendicular” includes a case at 90°±3.0°, preferably 90°±1.0°, and more preferably 90°+0.5°.

A total thickness of the elliptically polarizing plate of the present invention is preferably 80 to 250 μm, more preferably 110 to 220 μm, and most preferably 140 to 190 μm. The elliptically polarizing plate of the present invention may greatly contribute to reduction in thickness of a liquid crystal display apparatus. Hereinafter, each of the layers constituting the elliptically polarizing plate of the present invention will be described more specifically.

### A-2. First Birefringent Layer

As described above, the first birefringent layer 12 may serve as a so-called λ/2 plate. The first birefringent layer serves as a λ/2 plate, to thereby appropriately adjust retardation of wavelength dispersion characteristics (in particular, a wavelength range at which the retardation departs from λ/4) of the second birefringent layer serving as a λ/4 plate. An in-plane retardation (And) of the first birefringent layer at a wavelength of 590 nm is preferably 180 to 300 nm, more preferably 210 to 280 nm, and most preferably 230 to 240 nm. The in-plane retardation (And) is determined from an equation Δnd=(nx−ny)×d. Here, nx and ny are as described above. d represents a thickness of the first birefringent layer. The first birefringent layer 12 preferably has a refractive index profile of nx>ny=nz. In the present invention, the equation “ny=nz” includes not only a case where ny and nz are exactly the same, but also a case wherenyandnz are substantially equal.

A thickness of the first birefringent layer is set such that it serves as a λ/2 plate most appropriately. That is, the thickness thereof is set to provide a desired in-plane retardation. To be specific, the thickness is preferably 0.5 to 5 μm, more preferably 1 to 4 μm, and most preferably 1.5 to 3 μm.

Any appropriate liquid crystal material may be used as a material forming the first birefringent layer as long as the above characteristics are provided. A liquid crystal material (nematic liquid crystal) having a nematic phase as a liquid crystal phase is preferred. Examples of the liquid crystal material which can be used include a liquid crystal polymer and a liquid crystal monomer. Liquid crystallinity of the liquid crystal material may develop through a lyotropic mechanism or a thermotropic mechanism. Further, an alignment state of the liquid crystal is preferably homogeneous alignment. The liquid crystal polymer or the liquid crystal monomer may be used alone or in combination.

A liquid crystal monomer used as the liquid crystal material is preferably a polymerizable monomer and/or a crosslinking monomer, for example. As described below, this is because the alignment state of the liquid crystal monomer can be fixed by polymerizing or crosslinking the liquid crystal monomer. The alignment state of the liquid crystal monomer can be fixed by aligning the liquid crystal monomer, and then polymerizing or crosslinking the liquid crystal monomers, for example. A polymer is formed through polymerization, and a three-dimensional network structure is formed through crosslinking. However, the polymer and the three-dimensional network structure are not crystalline. Thus, the formed first birefringent layer will not undergo phase transition into a liquid crystal phase, a glass phase, or a crystal phase due to change in temperature, which is specific to a liquid crystal compound. As a result, the first birefringent layer is a birefringent layer which has excellent stability and is not affected by change in temperature.

Any appropriate liquid crystal monomer may be employed as the liquid crystal monomer. For example, there are used polymerizable mesogenic compounds and the like described in JP 2002-533742 A (WO 00/37585), EP 358208 (U.S. Pat. No. 5,211,877), EP 66137 (U.S. Pat. No. 4,388,453), WO 93/22397, EP 0261712, DE 19504224, DE 4408171, GB 2280445, and the like. Specific examples of the polymerizable mesogenic compounds include: LC242 (trade name) available from BASF Aktiengesellschaft; E7 (trade name) available from Merck & Co., Inc.; and LC-Silicone-CC3767 (trade name) available from Wacker-Chemie GmbH.

For example, a nematic liquid crystal monomer is preferred as the liquid crystal monomer, and a specific example thereof includes a monomer represented by the following formula (1). The liquid crystal monomer may be used alone or in combination of two or more thereof.

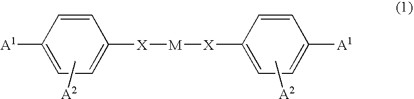

In the above formula (1), A¹ and A² each represent a polymerizable group, and may be the same or different from each other. One of A¹ and A² may represent hydrogen. Each X independently represents a single bond, —O—, —S—, —C═N—, —O—CO—, —CO—O—, —O—CO—O—, —CO—NR—, —NR—CO—, —NR—, —O—CO—NR—, —NR—CO—O—, —CH₂—O—, or —NR—CO—NR. R represents H or an alkyl group having 1 to 4 carbon atoms. M represents a mesogen group.

In the above formula (1), Xs may be the same or different from each other, but are preferably the same.

Of monomers represented by the above formula (1), each A² is preferably arranged in an ortho position with respect to A¹.

A¹ and A² are preferably each independently represented by the following formula (2), and A¹ and A² preferably represent the same group.

Z-X-(Sp)ₙ (2)

In the above formula (2), Z represents a crosslinking group, and X is the same as that defined in the above formula (1). Sp represents a spacer consisting of a substituted or unsubstituted linear or branched alkyl group having 1 to 30 carbon atoms. n represents 0 or 1. A carbon chain in Sp may be interrupted by oxygen in an ether functional group, sulfur in a thioether functional group, a non-adjacent imino group, an alkylimino group having 1 to 4 carbon atoms, or the like.

In the above formula (2), Z preferably represents any one of atomic groups represented by the following formulae. In the following formulae, examples of R include a methyl group, an ethyl group, an n-propyl group, an i-propyl group, an n-butyl group, an i-butyl group, and a t-butyl group.

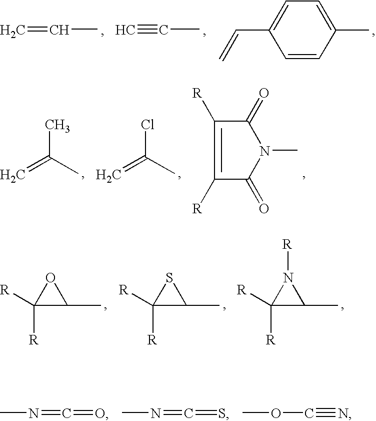

In the above formula (2), Sp preferably represents any one of atomic groups represented by the following formulae. In the following formulae, m preferably represents 1 to 3, and p preferably represents 1 to 12.

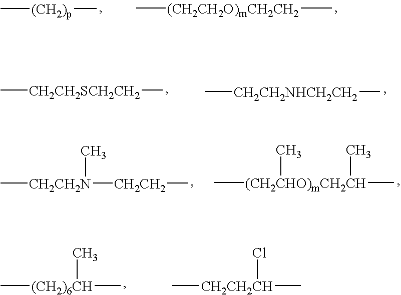

In the above formula (1), M is preferably represented by the following formula (3). In the following formula (3), X is the same as that defined in the above formula (1). Q represents a substituted or unsubstituted linear or branched alkylene group, or an aromatic hydrocarbon atomic group, for example. Q may represent a substituted or unsubstituted linear or branched alkylene group having 1 to 12 carbon atoms, for example.

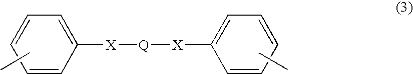

In the case where Q represents an aromatic hydrocarbon atomic group, Q preferably represents any one of atomic groups represented by the following formulae or substituted analogues thereof.

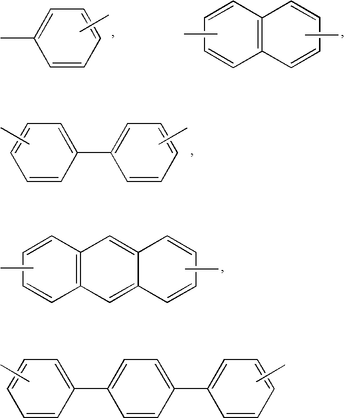

The substituted analogues of the aromatic hydrocarbon atomic groups represented by the above formulae may each have 1 to 4 substituents per aromatic ring, or 1 to 2 substituents per aromatic ring or group. The substituents may be the same or different from each other. Examples of the substituents include: an alkyl group having 1 to 4 carbon atoms; a nitro group; a halogen group such as F, Cl, Br, or I; a phenyl group; and an alkoxy group having 1 to 4 carbon atoms.

Specific examples of the liquid crystal monomer include monomers represented by the following formulae (4) to (19).

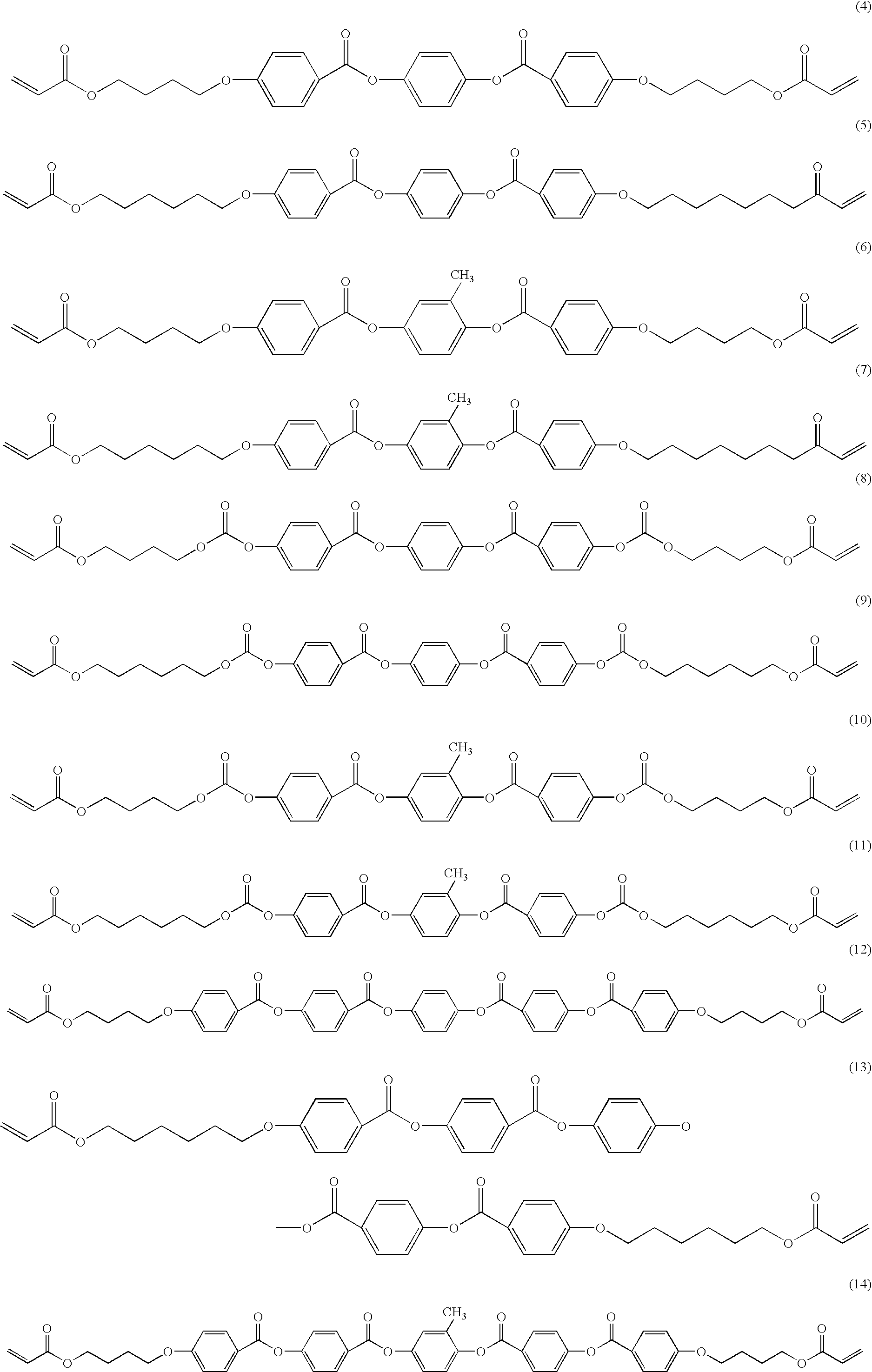

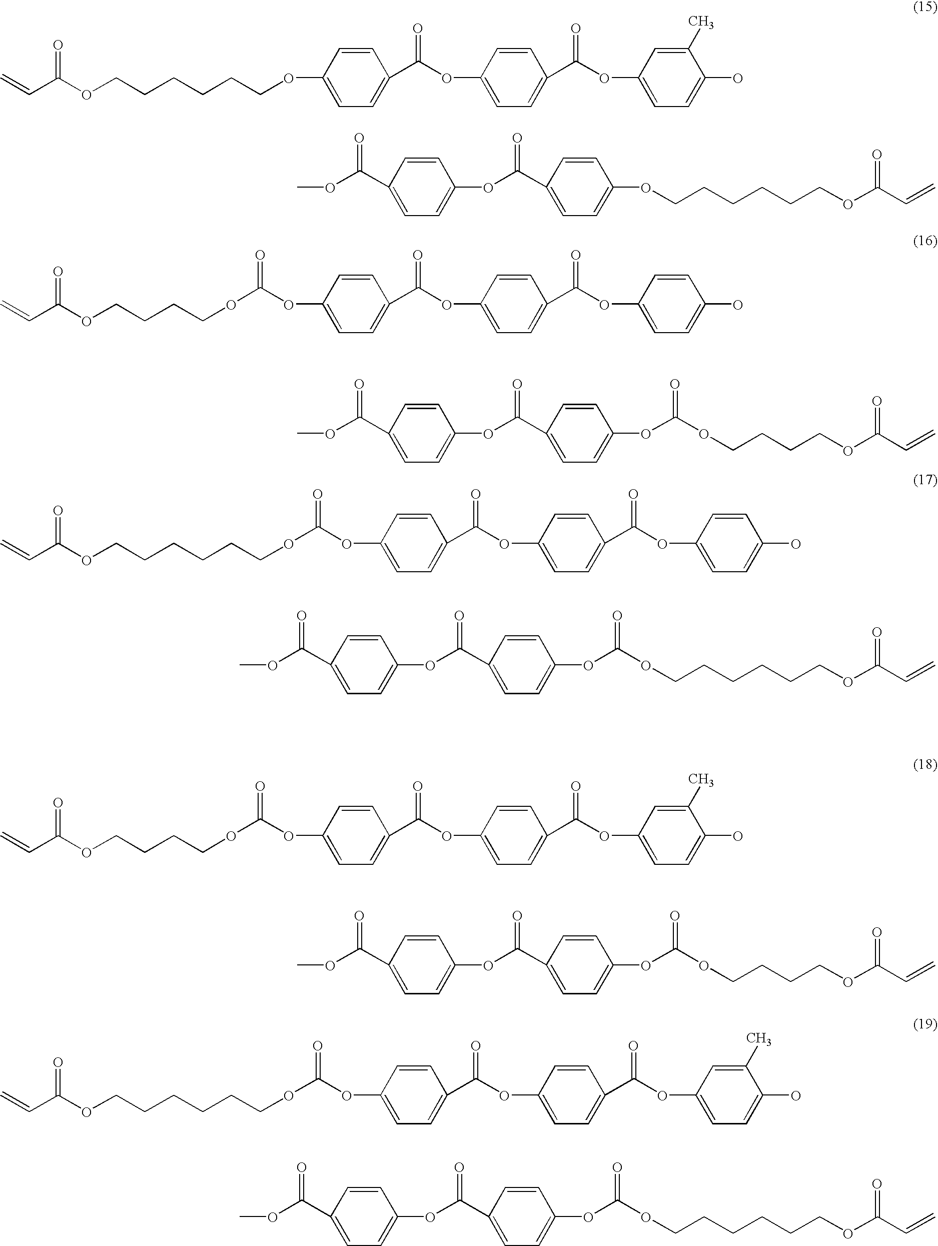

A temperature range in which the liquid crystal monomer exhibits liquid-crystallinity varies depending on the type of liquid crystal monomer. To be specific, the temperature range is preferably 40 to 120° C., more preferably 50 to 100° C., and most preferably 60 to 90° C.

### A-3. Second Birefringent Layer

As described above, the second birefringent layer 13 may serve as a so-called λ/4 plate. According to the present invention, the wavelength dispersion characteristics of the second birefringent layer serving as a λ/4 plate are corrected by optical characteristics of the first birefringent layer serving as a λ/2 plate, to thereby exhibit circularly polarizing function over a wide wavelength range. An in-plane retardation (Δnd) of the second birefringent layer at a wavelength of 550 nm is preferably 90 to 180 nm, more preferably 90 to 150 nm, and most preferably 105 to 135 nm. An Nz coefficient (=(nx−nz)/(nx−ny)) of the second birefringent layer is preferably 1.0 to 2.2, more preferably 1.2 to 2.0, and most preferably 1.4 to 1.8. Further, the second birefringent layer 13 preferably has a refractive index profile of nx>ny>nz.

A thickness of the second birefringent layer is set such that it serves as a λ/2 plate most appropriately. That is, the thickness thereof may be set to provide a desired retardation. To be specific, the thickness is preferably 10 to 100 μm, more preferably 20 to 80 μm, and most preferably 40 to 70 μm.

The second birefringent layer may be typically formed by subjecting a polymer film to stretching treatment. A second birefringent layer having the desired optical characteristics (such as refractive index profile, in-plane retardation, thickness direction retardation, and Nz coefficient) may be obtained by appropriately selecting the type of polymer, stretching conditions, a stretching method, and the like.

Any appropriate polymer may be employed as a polymer constituting the polymer film. Specific examples of the polymer include a polycarbonate-based polymer, a norbornene-based polymer, a cellulose-based polymer, a polyvinyl alcohol-based polymer, and a polysulfone-based polymer.

Alternatively, the second birefringent layer is constituted by a film formed of a resin composition containing polymerizable liquid crystal and a chiral agent. The polymerizable liquid crystal and the chiral agent are described in JP 2003-287623 A, which is incorporated herein by reference. For example, the above-described resin composition is applied onto any appropriate substrate, and the whole is heated to a temperature at which the polymerizable liquid crystal exhibits a liquid crystal state. Thus, the polymerizable liquid crystal is aligned in a twisted state (to be specific, by forming a cholesteric structure) by the chiral agent. The polymerizable liquid crystal is polymerized in this state, to thereby provide a film having the cholesteric structure fixed and aligned. A content of the chiral agent in the composition is adjusted, to allow change in degree of twist of the cholesteric structure. As a result, a direction of the slow axis of the second birefringent layer to be formed may be controlled. Such a film is very preferred because the direction of the slow axis can be set at an angle except parallel or perpendicular with respect to the absorption axis of the polarizer.

### A-4. Polarizer

Any appropriate polarizer may be employed as the polarizer 11 in accordance with the purpose. Examples thereof include: a film prepared by adsorbing a dichromatic substance such as iodine or a dichromatic dye on a hydrophilic polymer film such as a polyvinyl alcohol-based film, a partially formalized polyvinyl alcohol-based film, or a partially saponified ethylene/vinyl acetate copolymer-based film and uniaxially stretching the film; and a polyene-based aligned film such as a dehydrated product of a polyvinyl alcohol-based film or a dehydrochlorinated product of a polyvinyl chloride-based film. Of those, a polarizer prepared by adsorbing a dichromatic substance such as iodine on a polyvinyl alcohol-based film and uniaxially stretching the film is particularly preferred because of high polarized dichromaticity. A thickness of the polarizer is not particularly limited, but is generally about 1 to 80 μm.

The polarizer prepared by adsorbing iodine on a polyvinyl alcohol-based film and uniaxially stretching the film may be produced by, for example: immersing a polyvinyl alcohol-based film in an aqueous solution of iodine for coloring; and stretching the film to a 3 to 7 times length of the original length. The aqueous solution may contain boric acid, zinc sulfate, zinc chloride, or the like as required, or the polyvinyl alcohol-based film may be immersed in an aqueous solution of potassium iodide or the like. Further, the polyvinyl alcohol-based film may be immersed and washed in water before coloring as required.

Washing the polyvinyl alcohol-based film with water not only allows removal of contamination on a film surface or washing away of an antiblocking agent, but also provides an effect of preventing nonuniformity such as uneven coloring by swelling the polyvinyl alcohol-based film. The stretching of the film may be performed after coloring of the film with iodine, performed during coloring of the film, or performed followed by coloring of the film with iodine. The stretching may be performed in an aqueous solution of boric acid or potassium iodide, or in a water bath.

### A-5. Protective Layer

The first protective layer 14 and the second protective layer 15 are each formed of any appropriate film which can be used as a protective layer for a polarizing plate. The film is preferably a transparent protective film. Specific examples of a material used as a main component of the film include transparent resins such as a cellulose-based resin (such as triacetylcellulose (TAC)), a polyester-based resin, a polyvinyl alcohol-based resin, a polycarbonate-based resin, a polyamide-based resin, a polyimide-based resin, a polyether sulfone-based resin, a polysulfone-based resin, a polystyrene-based resin, a polynorbornene-based resin, a polyolefin-based resin, an acrylic resin, and an acetate-based resin. Another example thereof includes an acrylic, urethane-based, acrylic urethane-based, epoxy-based, or silicone-based thermosetting resin or UV-curing resin. Still another example thereof includes a glassy polymer such as a siloxane-based polymer. Further, a polymer film described in JP 2001-343529 A (WO 01/37007) may also be used. The film is formed of a resin composition containing a thermoplastic resin having a substituted or unsubstituted imide group on a side chain, and a thermoplastic resin having a substituted or unsubstituted phenyl group and a nitrile group on a side chain. Examples thereof include a resin composition containing an alternate copolymer of isobutene and N-methylmaleimide, and an acrylonitrile/styrene copolymer. The polymer film may be an extruded product of the above-mentioned resin composition, for example. Of those, TAC, a polyimide-based resin, a polyvinyl alcohol-based resin, and a glassypolymer are preferred.

It is preferred that the protective layer be transparent and color less. To be specific, the protective layer has a thickness direction retardation of preferably −90 nm to +90 nm, more preferably −80 nm to +80 nm, and most preferably −70 nm to +70 nm.

The protective layer has any appropriate thickness as long as the preferred thickness direction retardation can be obtained. To be specific, the thickness of the protective layer is preferably 5 mm or less, more preferably 1 mm or less, particularly preferably 1 to 500 μm, and most preferably 5 to 150 μm.

The surface of the second protective layer opposite to that of the polarizer (that is, the outermost part of the polarizing plate) may be subjected to hard coat treatment, antireflection treatment, anti-sticking treatment, anti-glare treatment, or the like as required.

### B. Method of Producing Elliptically Polarizing Plate

A method of producing an elliptically polarizing plate according to an embodiment of the present invention includes the steps of: forming a first birefringent layer on a surface of a transparent protective film (T); laminating a polarizer on a surface of the transparent protective film (T); and forming a second birefringent layer by laminating a polymer film on a surface of the first birefringent layer, in which the first birefringent layer and the polarizer are arranged so as to oppose each other through the transparent protective film (T), the step of forming the first birefringent layer including the steps of: applying a application liquid containing a liquid crystal material onto a substrate subjected to the alignment treatment; forming a first birefringent layer on the substrate by subjecting the applied liquid crystal material to a temperature at which the liquid crystal material represents a liquid crystal phase; and transferring the first birefringent layer formed on the substrate to a surface of the transparent protective film (T). Here, the elliptically polarizing plate has angles α and β in a relationship represented by the following expression (1):

2α+40°<β<2α+50° (1)

wherein, α represents an angle between an absorption axis of the polarizer and a slow axis of the first birefringent layer, and β represents an angle between the absorption axis of the polarizer and a slow axis of the second birefringent layer.
Such a production method provides the elliptically polarizing plate shown in FIG. 1, for example.

The order of the steps may be appropriately changed in accordance with a laminated structure of the target elliptically polarizing plate. For example, the step of laminating the polarizer may be performed after the step of forming or laminating any one of the birefringent layers. Hereinafter, description is given of each of the steps.

### B-1. Step of Forming First Birefringent Layer

The first birefringent layer is formed on the surface of the transparent protective film (T). A specific procedure for the step of forming a first birefringent layer is described below.

First, the application liquid containing a liquid crystal material is applied to the substrate subjected to alignment treatment.

Any appropriate substrate may be used as long as an appropriate first birefringent layer of the present invention can be obtained. Any appropriate substrate may be employed as the substrate. Specific examples thereof include a glass substrate, a metal foil, a plastic sheet, and aplastic film. Note that an aligned film may be provided or not provided on the substrate. Any appropriate film may be used for the plastic film. A specific example thereof is a film formed of a transparent polymer such as: a polyester-based polymer such as polyethylene terephthalate or polyethylene naphthalate; a cellulose-based polymer such as diacetyl cellulose or triacetyl cellulose; a polycarbonate-based polymer; or an acrylic polymer such as polymethyl methacrylate. Another specific example thereof is a film formed of a transparent polymer such as: a styrene-based polymer such as polystyrene or an acrylonitrile/styrene copolymer; an olefin-based polymer such as polyethylene, polypropylene, a polyolefin having a cyclic or norbornene structure, or an ethylene/propylene copolymer; a vinyl chloride-based polymer; or an amide-based polymer such as nylon or aromatic polyamide. Still another specific example thereof is a film formed of a transparent polymer such as an imide-based polymer, a sulfone-based polymer, a polyethersulfone-based polymer, a polyetheretherketone-based polymer, a polyphenylene sulfide-based polymer, a vinyl alcohol-based polymer, a vinylidene chloride-based polymer, a vinyl butyral-based polymer, an arylate-based polymer, a polyoxymethylene-based polymer, an epoxy-based polymer, or a blended product thereof. Of those, a polyethyleneterephthalate (PET) film is preferred.

The substrate has a thickness of preferably 20 to 100 μm, more preferably 30 to 90 μm, and most preferably 30 to 80 μm. The substrate has a thickness within the above ranges, and thus provides strength for favorably supporting the very thin first birefringent layer in the lamination step and provides appropriately maintained operability such as sliding property or roll traveling property.

Any appropriate alignment treatment may be employed for the alignment treatment of the substrate as long as an appropriate first birefringent layer of the present invention can be obtained. Examples thereof include rubbing treatment, oblique deposition method, stretching treatment, photoalignment treatment, magnetic field alignment treatment, and electrical field alignment treatment. The rubbing treatment is preferred.

The alignment direction of the alignment treatment refers to a direction at a predetermined angle with respect to the absorption axis of the polarizer when the polarizer is laminated. The alignment direction is substantially the same as the direction of the slow axis of the formed first birefringent layer 12. Thus, the predetermined angle is preferably +8° to +38° or −8° to −38°, more preferably +13° to +33° or −13° to −33°, particularly preferably +19° to +29° or −19° to −29°, especially preferably +21° to +27° or −21° to −27°, and most preferably +23° to +24° or −23° to −24°.

The application liquid containing a liquid crystal material used for forming the first birefringent layer is applied to the substrate subjected to the alignment treatment, to thereby align the liquid crystal material on the substrate. The alignment of the liquid crystal material is performed through treatment at a temperature at which the liquid crystal material exhibits a liquid crystal phase in accordance with the type of liquid crystal material used. Through such temperature treatment, the liquid crystal material converts into a liquid crystal state, and the liquid crystal material aligns in accordance with an alignment direction of the surface of the substrate. In this way, birefringence generates in a layer formed through application, to thereby form the first birefringent layer.

The application liquid containing a liquid crystal material is prepared by dissolving or dispersing the liquid crystal material in an appropriate solvent.

Any appropriate solvent which may dissolve or disperse the liquid crystal material may be employed as the solvent. The type of solvent to be used may be appropriately selected in accordance with the type of liquid crystal material or the like. Specific examples of the solvent include: halogenated hydrocarbons such as chloroform, dichloromethane, carbon tetrachloride, dichloroethane, tetrachloroethane, methylene chloride, trichloroethylene, tetrachloroethylene, chlorobenzene, and orthodichlorobenzene; phenols such as phenol, p-chlorophenol, o-chlorophenol, m-cresol, o-cresol, and p-cresol; aromatic hydrocarbons such as benzene, toluene, xylene, mesitylene, methoxybenzene, and 1,2-dimethoxybenzene; ketone-based solvents such as acetone, methyl ethyl ketone (MEK), methyl isobutyl ketone, cyclohexanone, cyclopentanone, 2-pyrrolidone, and N-methyl-2-pyrrolidone; ester-based solvents such as ethyl acetate, butyl acetate, and propyl acetate; alcohol-based solvents such as t-butyl alcohol, glycerin, ethylene glycol, triethylene glycol, ethylene glycol monomethyl ether, diethylene glycol dimethyl ether, propylene glycol, dipropylene glycol, and 2-methyl-2,4-pentanediol; amide-based solvents such as dimethylformamide and dimethylacetamide; nitrile-based solvents such as acetonitrile and butyronitrile; ether-based solvents such as diethyl ether, dibutyl ether, tetra hydrofuran, and dioxane; and carbon disulfide, ethylcellosolve, butyl cellosolve, and ethyl cellosolve acetate. Of those, toluene, xylene, mesitylene, MEK, methyl isobutyl ketone, cyclohexanone, ethyl cellosolve, butyl cellosolve, ethyl acetate, butyl acetate, propyl acetate, and ethyl cellosolve acetate are preferred. The solvent may be used alone or in combination of two or more types thereof.

A content of the liquid crystal material in the application liquid may be appropriately determined in accordance with the type of liquid crystal material, the thickness of the target layer, and the like. To be specific, the content of the liquid crystal material is preferably 5 to 50 wt %, more preferably 10 to 40 wt %, and most preferably 15 to 30 wt %.

The application liquid may further contain any appropriate additive as required. Specific examples of the additive include a polymerization initiator and a crosslinking agent. The additives are particularly suitably used when a liquid crystal monomer is used as the liquid crystal material. Specific examples of the polymerization initiator include benzoylperoxide (BPO) and azobisisobutyronitrile (AIBN). Specific examples of the crosslinking agent include an isocyanate-based crosslinking agent, an epoxy-based crosslinking agent, and a metal chelate crosslinking agent. The additives may be used alone or in combination of two or more thereof. Specific examples of other additives include an antioxidant, a modifier, a surfactant, a dye, a pigment, a discoloration inhibitor, and a UV absorber. The additives may be used alone or in combination of two or more thereof. Examples of the antioxidant include a phenol-based compound, an amine-based compound, an organic sulfur-based compound, and a phosphine-based compound. Examples of the modifier include glycols, silicones, and alcohols. The surfactant is used for smoothing a surface of an optical film, for example. Specific examples thereof include a silicone-based surfactant, an acrylic surfactant, and a fluorine-based surfactant.

An application amount of the application liquid may be appropriately determined in accordance with a concentration of the application liquid, the thickness of the target layer, and the like. In a case where the concentration of the liquid crystal material is 20 wt % in the application liquid, the application amount is preferably 0.03 to 0.17 ml, more preferably 0.05 to 0.15 ml, and most preferably 0.08 to 0.12 ml per 100 cm² of the substrate.

Any appropriate application method may be employed as an application method. Specific examples thereof include roll coating, spin coating, wire bar coating, dip coating, extrusion, curtain coating, and spray coating.

Next, the liquid crystal material forming the first birefringent layer is aligned in accordance with the alignment direction of the surface of the substrate. The liquid crystal material is aligned through treatment at a temperature exhibiting a liquid crystal phase in accordance with the type of liquid crystal material used. The treatment at such a temperature allows the liquid crystal material to be in a liquid crystal state, and the liquid crystal material is aligned in accordance with the alignment direction of the surface of the substrate. Thus, birefringence is caused in the layer formed through application, to thereby form the first birefringent layer.

A treatment temperature may be appropriately determined in accordance with the type of liquid crystal material. To be specific, the treatment temperature is preferably 40 to 120° C., more preferably 50 to 100° C., and most preferably 60 to 90° C. A treatment time is preferably 30 seconds or more, more preferably 1 minute or more, particularly preferably 2 minutes or more, and most preferably 4 minutes or more. The treatment time of less than 30 seconds may provide an insufficient liquid crystal state of the liquid crystal material. Meanwhile, the treatment time is preferably 10 minutes or less, more preferably 8 minutes or less, and most preferably 7 minutes or less. The treatment time exceeding 10 minutes may cause sublimation of additives.

In a case where the liquid crystal monomer is used as the liquid crystal material, the layer formed through the application is preferably further subjected to polymerization treatment or crosslinking treatment. The polymerization treatment allows the liquid crystal monomer to polymerize and to be fixed as a repeating unit of a polymer molecule. In addition, the crosslinking treatment allows the liquid crystal monomer to form a three-dimensional structure and to be fixed as a part of a crosslinked structure. As a result, the alignment state of the liquid crystal material is fixed. The polymer or three-dimensional structure formed through polymerization or crosslinking of the liquid crystal monomer is “non-liquid crystal”. Thus, the formed first birefringent layer will not undergo phase transition into a liquid crystal phase, a glass phase, or a crystal phase by change in temperature, which is specific to a liquid crystal molecule.

A specific procedure for the polymerization treatment or crosslinking treatment may be appropriately selected in accordance with the type of polymerization initiator or crosslinking agent to be used. For example, in a case where a photopolymerization initiator or a photocrosslinking agent is used, photoirradiation may be performed. In a case where a UV polymerization initiator or a UV crosslinking agent is used, UV irradiation may be performed. The irradiation time, irradiation intensity, total amount of irradiation, and the like of light or UV light may be appropriately set in accordance with the type of liquid crystal material, the type of substrate, the type of alignment treatment, desired characteristics for the first birefringent layer, and the like.

Next, the first birefringent layer formed on the substrate is transferred to the surface of the transparent protective film (T). A transfer method is not particularly limited, and the first birefringent layer supported on the substrate is attached to the transparent protective film (T) through an adhesive, for example. The transfer method is employed, to thereby provide an elliptically polarizing plate having excellent adhesiveness between films (layers) at excellent production efficiency.

A typical example of the adhesive is a curable adhesive. Typical examples of the curable adhesive include: a photo-curable adhesive such as a UV-curable adhesive; a moisture-curable adhesive; and a heat-curable adhesive. A specific example of the heat-curable adhesive is a heat-curable resin-based adhesive formed of an epoxy resin, an isocyanate resin, a polyimide resin, or the like. A specific example of the moisture-curable adhesive is an isocyanate resin-based moisture-curable adhesive. The moisture-curable adhesive (in particular, an isocyanate resin-based moisture-curable adhesive) is preferred. The moisture-curable adhesive cures through a reaction with moisture in air, water adsorbed on a surface of an adherend, an active hydrogen group of a carboxyl group, a hydroxyl group, or the like, etc. Thus, the adhesive may be applied and then cured naturally by leaving at stand, and has excellent operability. Further, the moisture-curable adhesive requires no heating for curing, and thus the first birefringent layer and the transparent protective film (T) are not heated during attaching (bonding). As a result, no heat shrinkage occurs, and thus formation of cracks during lamination or the like may significantly be prevented even in the case where the first birefringent layer and the transparent protective film (T) each have a very small thickness as in the present invention. Note that the isocyanate resin-based adhesive is a general term for a polyisocyanate-based adhesive and a polyurethane resin adhesive.

For example, a commercially available adhesive may be used as the curable adhesive, or various curable resins may be dissolved or dispersed in a solvent to prepare a curable resin adhesive solution (or dispersion). In the case where the solution (or dispersion) is prepared, a ratio of the curable resin in the solution is preferably 10 to 80 wt %, more preferably 20 to 65%, especially preferably 25 to 65 wt %, and most preferably 30 to 50 wt % in solid content. Any appropriate solvent may be used as the solvent to be used in accordance with the type of curable resin, and specific examples thereof include ethyl acetate, methyl ethyl ketone, methyl isobutyl ketone, toluene, and xylene. One type of solvent may be used alone, or two or more types thereof may be used in combination.

An application amount of the adhesive may appropriately be set in accordance with the purpose. For example, the application amount is preferably 0.3 to 3 ml, more preferably 0.5 to 2 ml, and most preferably 1 to 2 ml per are a (cm²) of the first birefringent layer or the transparent protective film. After the application, the solvent in the adhesive is evaporated through natural drying or heat drying as required. A thickness of the adhesive layer to be obtained is preferably 0.1 to 20 μm, more preferably 0.5 to 15 μm, and most preferably 1 to 10 μm. Microhardness of the adhesive layer is preferably 0.1 to 0.5 GPa, more preferably 0.2 to 0.5 GPa, and most preferably 0.3 to 0.4 GPa. Correlation between Microhardness and Vickers hardness is known, and thus Microhardness may be converted into Vickers hardness. Microhardness may be calculated from indentation depth and indentation load by using a thin-film hardness meter (trade name, MH4000 or MHA-400, for example) manufactured by NEC Corporation.

Finally, the substrate is peeled off from the first birefringent layer, to thereby complete the lamination of the first birefringent layer and the transparent protective film (T).

### B-2. Step of Laminating Polarizer

A polarizer is laminated on the surface of the transparent protective film (T). As described above, the polarizer is laminated at any appropriate point in time in the production method of the present invention. For example, the polarizer may be laminated on the transparent protective film (T) in advance, may be laminated after the first birefringent layer is formed, or may be laminated after the second birefringent layer is formed.

Any appropriate lamination method (such as adhesion) may be employed as a method of laminating the transparent protective film (T) and the polarizer. The adhesion may be performed by using any appropriate adhesive or pressure sensitive adhesive. The type of adhesive or pressure sensitive adhesive may be appropriately selected in accordance with the type of adherend (that is, transparent protective film and polarizer). Specific examples of the adhesive include: acrylic, vinyl alcohol-based, silicone-based, polyester-based, polyurethane-based, and polyether-based polymer adhesives; isocyanate-based adhesives; and rubber-based adhesives. Specific examples of the pressure sensitive adhesive include acrylic, vinyl alcohol-based, silicone-based, polyester-based, polyurethane-based, polyether-based, isocyanate-based, and rubber-based pressure sensitive adhesives.

A thickness of the adhesive or pressure sensitive adhesive is not particularly limited, but is preferably 10 to 200 nm, more preferably 30 to 180 nm, and most preferably 50 to 150 nm.

According to the production method of the present invention, the slow axis of the first birefringent layer may be set in the alignment treatment for the substrate. Thus, a continuous polarizing film (polarizer) stretched in a longitudinal direction (that is, film having an absorption axis in the longitudinal direction) can be used. In other words, a continuous first birefringent layer subjected to the alignment treatment at a predetermined angle with respect to its longitudinal direction (a first birefringent layer formed on the substrate), a continuous transparent protective film (T), and a continuous polarizing film (polarizer) may be continuously attached together with the respective longitudinal directions in the same direction. Thus, an elliptically polarizing plate can be obtained at very high production efficiency. According to the method, the film need not be cut out obliquely with respect to its longitudinal direction (stretching direction) for lamination. As a result, angles of optical axes do not vary by cut-out film, resulting in an elliptically polarizing film without variation in quality by product. Further, no wastes are produced by cutting of the film, and the elliptically polarizing plate can be obtained at low cost and production of a large polarizing plate is facilitated. The direction of the absorption axis of the polarizer is substantially in parallel with the longitudinal direction of the continues film.

### B-3 Step of Forming Second Birefringent Layer

Further, the second birefringent layer is formed on the surface of the first birefringent layer. In general, the second birefringent layer is formed by laminating the polymer film on the surface of the first birefringent layer. The polymer film is preferably a stretched film. A lamination method is not particularly limited, and any appropriate adhesive or pressure sensitive adhesive (such as an adhesive or pressure sensitive adhesive as described above) is used for lamination.

Alternatively, as described above, a resin composition containing polymerizable liquid crystal and achiral agent is applied onto any appropriate substrate, and the whole is heated to a temperature at which the polymerizable liquid crystal exhibits a liquid crystal state. Thus, the polymerizable liquid crystal is aligned in a twisted state (to be specific, by forming a cholesteric structure) by the chiral agent. The polymerizable liquid crystal is polymerized in this state, to thereby provide a film having the cholesteric structure fixed and aligned. The film is transferred onto the surface of the first birefringent layer from the substrate, to thereby form the second birefringent layer 13.

### B-4. Specific Production Procedure

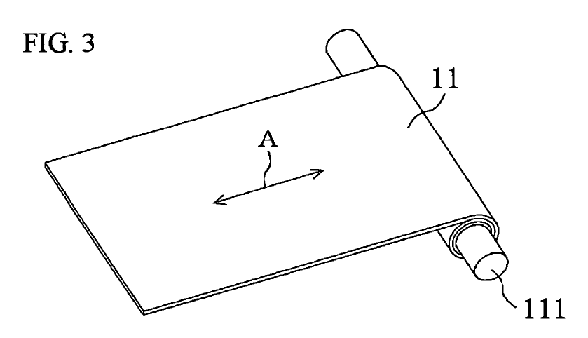

A specific procedure for the production method of the present invention will be described with reference to FIGS. 3 to 8. In FIGS. 3 to 8, reference numerals 111, 111′, 112, 112′, 113, 114, 115, 116, 117, 118, 118′, 119, and 119′ each represent a roll for rolling a film and/or a laminate forming each layer.

First, a continuous polymer film is prepared as a raw material for a polarizer, and is colored, stretched, and the like as described above. The continues polymer film is stretched continuously in a longitudinal direction. In this way, as shown in a perspective view of FIG. 3, the continues polarizer 11 having an absorption axis in a longitudinal direction (stretching direction: direction of arrow A) is obtained.

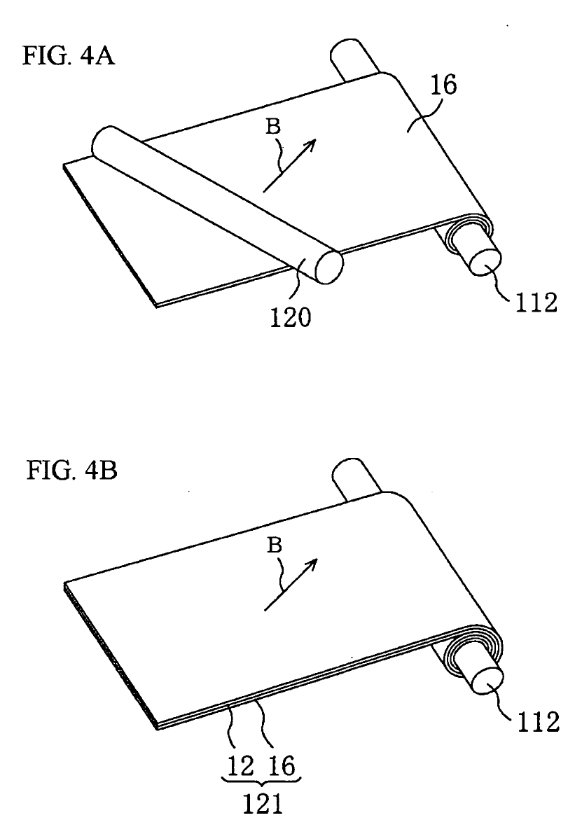

Meanwhile, as shown in a perspective view of FIG. 4A, the continuous substrate 16 is prepared, and a surface of the substrate is subjected to rubbing treatment by using a rubbing roll 120. At this time, a rubbing direction is in a direction different from a longitudinal direction of the transparent protective film 14 such as +23° to +24° or −23° to −24°. Next, as shown in a perspective view of FIG. 4B, the first birefringent layer 12 is formed on the substrate 16 subjected to the rubbing treatment as described in the sections B-1. The first birefringent layer 12 has a liquid crystal material aligned along the rubbing direction, and the direction of its slow axis is in substantially the same direction (direction of arrow B) as the rubbing direction of the substrate 16.

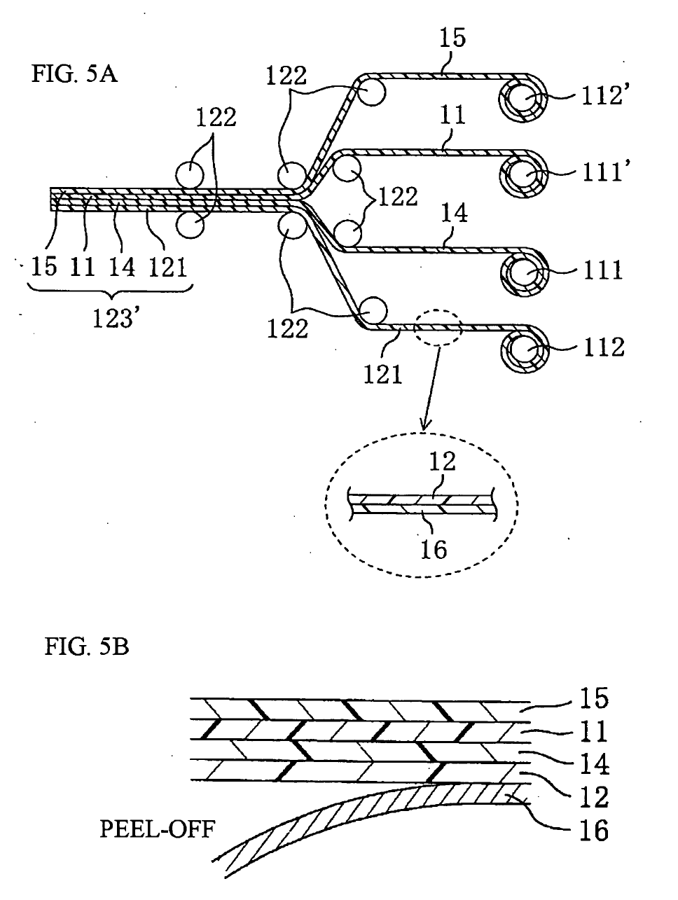

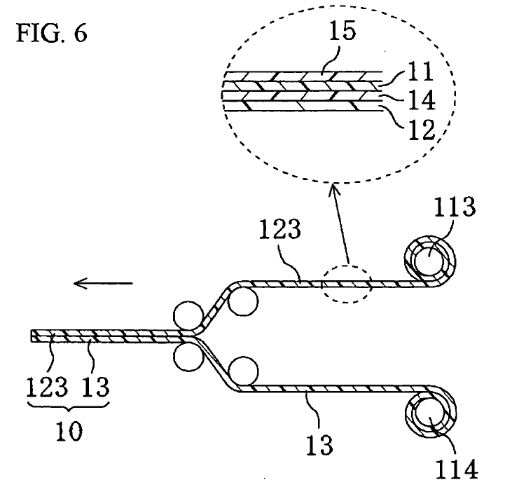

Next, as shown in a schematic diagram of FIG. 5A, the polarizer 11, the transparent protective film (the protective layer) 14, and a laminate 121 of the first birefringent layer 12 and the substrate 16 are delivered in a direction of an arrow, and are attached together by Using an adhesive or the like (not shown) with the respective longitudinal directions in the same direction. In FIG. 5A, reference numeral 122 represents a guide roll for attaching together the films (the same also applies in FIGS. 6 to 8). Alternatively, the second transparent protective film (protective layer) 15 may be attached to the opposite side of the polarizer 11 having the transparent protective film (protective layer) 14.

Next, as shown in FIG. 5B, the substrate 16 is peeled off from a laminate 123′ (laminate including the second transparent protective film (protective layer) 15, the polarizer 11, the transparent protective film (protective layer) 14, the first birefringent layer 12, and the substrate 16) obtained by using the second transparent protective film (protective layer) 15, to thereby obtain a laminate 123 (laminate including the second transparent protective film (protective layer) 15, the polarizer 11, the transparent protective film (protective layer) 14, and the first birefringent layer 12).

Further, as shown in a schematic diagram of FIG. 6, the continuous second birefringent layer 13 is prepared, and the continuous second birefringent layer 13 and a laminate 123 (of the second transparent protective film (protective layer) 15, the polarizer 11, the transparent protective film (protective layer) 14, and the first birefringent layer 12) are delivered in a direction of an arrow, and are attached together by using an adhesive or the like (not shown) with the respective longitudinal directions in the same direction.

As described above, the direction (angle α) of the slow axis of the first birefringent layer 12 is set to +23° to +24° or −23° to −24° with respect to the longitudinal direction of the film (absorption axis of the polarizer 11). In addition, a relationship represented by an expression β=2α+45° provides an angle β of 91° to 93° or −3° to −1°. That is, the slow axis of the second birefringent layer 13 may be substantially perpendicular to the longitudinal direction of the film (absorption axis of the polarizer 11). As a result, a general stretched polymer film laterally stretched in a direction perpendicular to the longitudinal direction can be used, thereby significantly improving the production efficiency.

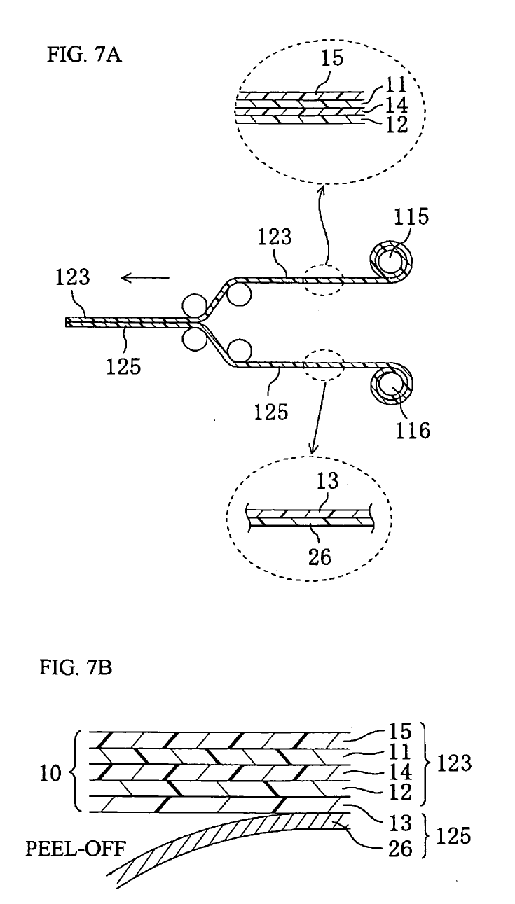

In a case where a resin composition containing polymerizable liquid crystal and a chiral agent is used as the second birefringent layer 13, a procedure as shown in FIGS. 7A and 7B may be employed. That is, as shown in a schematic diagram of FIG. 7A, a laminate 125 (formed through application of the second birefringent layer 13 on a substrate 26) is prepared. The laminate 125 and the laminate 123 (of the transparent protective film (protective layer) 15, the polarizer 11, the transparent protective film (protective layer) 14, and the first birefringent layer 12) are delivered in a direction of an arrow, and are attached together by using an adhesive or the like (not shown) with the respective longitudinal directions in the same direction. Finally, as shown in FIG. 7B, the substrate 26 is peeled off from the attached laminates.

As described above, the elliptically polarizing plate 10 of the present invention is obtained.

Another example of the specific procedure for the production method of the present invention will be described.

As described above and shown in a perspective view of FIG. 3, the continuous polarizer 11 is produced. Further, as described above and shown in perspective views of FIGS. 4A and 4B, the laminate 121 having the first birefringent layer 12 formed on the substrate 16 is produced.

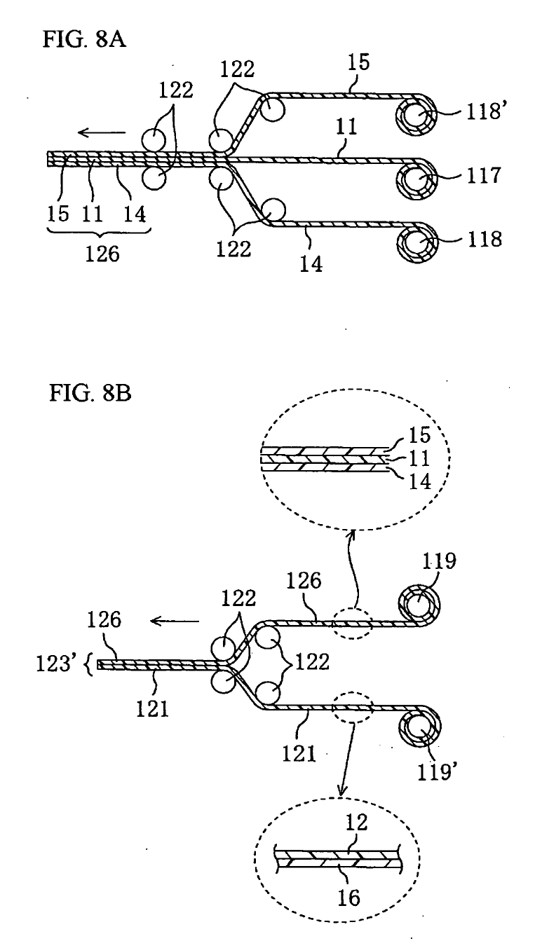

Next, as shown in a schematic diagram of FIG. 8A, the polarizer 11, the transparent protective film (protective layer) 14, and the second transparent protective film (protective layer) 15 are delivered in a direction of an arrow, and are attached together by using an adhesive or the like (not shown) with the respective longitudinal directions in the same direction. As a result, a laminate 126 of second transparent protective film (protective layer) 15/polarizer 11/transparent protective film (protective layer) 14 is obtained.

Then, as shown in a schematic diagram of FIG. 8B, the laminate 126 of second transparent protective film (protective layer) 15/polarizer 11/transparent protective film (protective layer) 14 and the laminate 121 of first birefringent layer 12/substrate 16 are delivered in a direction of an arrow, and are attached together by using an adhesive or the like (not shown) with the respective longitudinal directions in the same direction. As a result, the laminate 123′ of second transparent protective film (protective layer) 15/polarizer 11/transparent protective film (protective layer) 14/first birefringent layer 12/substrate 16 is obtained.

Next, as shown in FIG. 5B, the substrate 16 is peeled off from the laminate 1231, to thereby obtain the laminate 123 (laminate of second transparent protective film (protective layer) 15/polarizer 11/transparent protective film (protective layer) 14/first birefringent layer 12).

Further, as shown in a schematic diagram of FIG. 6, the continuous second birefringent layer 13 is prepared, and the continuous second birefringent layer 13 and a laminate 123 are delivered in a direction of an arrow, and are attached together by using an adhesive or the like (not shown) with the respective longitudinal directions in the same direction.

As described above, the direction (angle α) of the slow axis of the first birefringent layer 12 is set to +23° to +24° or −23° to −24° with respect to the longitudinal direction of the film (absorption axis of the polarizer 11). In addition, a relationship represented by an expression β=2α+45° provides an angle β of 91° to 93° or −3° to −1°. That is, the slow axis of the second birefringent layer 13 may be substantially perpendicular to the longitudinal direction of the film (absorption axis of the polarizer 11). As a result, a general stretched polymer film laterally stretched in a direction perpendicular to the longitudinal direction can be used, thereby significantly improving the production efficiency.

In a case where a resin composition containing polymerizable liquid crystal and a chiral agent is used as the second birefringent layer 13, a procedure as shown in FIG. 7 may be employed. That is, as shown in a schematic diagram of FIG. 7A, a laminate 125 (formed through application of the second birefringent layer 13 on a substrate 26) is prepared. The laminate 125 and the laminate 123 (of the transparent protective film (protective layer) 15/the polarizer 11/the transparent protective film (protective layer) 14/the first birefringent layer 12) are delivered in a direction of an arrow, and are attached together by using an adhesive or the like (not shown) with the respective longitudinal directions in the same direction. Finally, as shown in FIG. 7B, the substrate 26 is peeled off from the attached laminates.

As described above, the elliptically polarizing plate 10 of the present invention is obtained.

### B-5. Other Components of Elliptically Polarizing Plate

The elliptically polarizing plate of the present invention may further include another optical layer. Any appropriate optical layer may be employed as the other optical layer in accordance with the purpose or the type of image display apparatus. Specific examples of the other optical layer include a birefringent layer (retardation film), a liquid crystal film, a light scattering film, and a diffraction film.

The elliptically polarizing plate of the present invention may further include an sticking layer as an outermost layer on at least one side. Inclusion of the sticking layer as an outermost layer facilitates lamination of the elliptically polarizing plate with other members (such as liquid crystal cell), to thereby prevent peeling off of the elliptically polarizing plate from other members. Any appropriate material may be employed as a material for the sticking layer. Specific examples of the adhesive include those described in the section B-4. A material having excellent humidity resistance and thermal resistance is preferably used. This is because the material can prevent foaming or peeling due to moisture absorption, degradation of optical characteristics and warping of a liquid crystal cell due to difference in thermal expansion, and the like.

For practical purposes, the surface of the sticking layer is covered with any appropriate separator until the elliptically polarizing plate is actually used, to thereby prevent contamination. The separator may be formed on any appropriate film as required by providing a release coating by using a silicone-based, long-chain alkyl-based, fluorine-based, or molybdenum sulfide release agent, for example.

Each layer of the elliptically polarizing plate of the present invention may be provided with UV absorbability through treatment or the like with a UV absorber such as a salicylate-based compound, a benzophenone-based compound, a benzotriazole-based compound, a cyanoacrylate-based compound, or a nickel complex salt-based compound.

### C. Use of Elliptically Polarizing Plate

The elliptically polarizing plate of the present invention may be suitably used for various image display apparatuses (such as liquid crystal display apparatus and selfluminous display apparatus). Specific examples of the image display apparatus for which the elliptically polarizing plate may be used include a liquid crystal display apparatus, an EL display, a plasma display (PD), and a field emission display (FED). The elliptically polarizing plate of the present invention used for a liquid crystal display apparatus is useful for visible angle compensation, for example. The elliptically polarizing plate of the present invention is used for a liquid crystal display apparatus of a circularly polarization mode, and is particularly useful for a homogeneous alignment TN liquid crystal display apparatus, in-plane switching (IPS) liquid crystal display apparatus, and a vertical alignment (VA) liquid crystal display apparatus. The elliptically polarizing plate of the present invention used for an EL display is useful for prevention of electrode reflection, for example.

### D. Image Display Apparatus

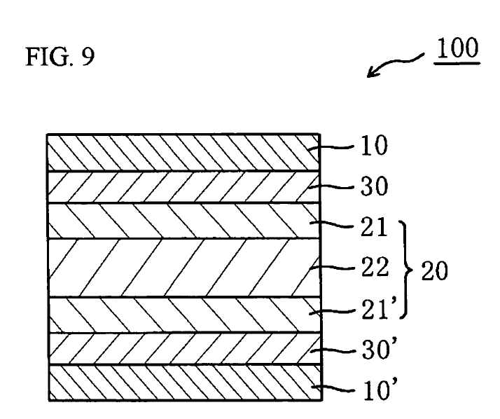

A liquid crystal display apparatus will be described as an example of an image display apparatus of the present invention. Here, a liquid crystal panel used for the liquid crystal display apparatus will be described. Any appropriate constitution may be employed for a constitution of the liquid crystal display apparatus excluding the liquid crystal panel in accordance with the purpose. FIG. 9 is a schematic sectional view of a liquid crystal panel according to a preferred embodiment of the present invention. A liquid crystal panel 100 includes: a liquid crystal cell 20, retardation plates 30 and 30′ arranged on both sides of the liquid crystal cell 20; and polarizing plates 10 and 10′ arranged on outer sides of the respective retardation plates. Arbitrary and appropriate retardation plates may be employed as the retardation plates 30 and 30′ in accordance with the purpose and an alignment mode of the liquid crystal cell. At least one of the retardation plates 30 and 30′ may be omitted in accordance with the purpose and the alignment mode of the liquid crystal cell. The polarizing plate 10 is the elliptically polarizing plate of the present invention as described above. The polarizing plate (elliptically polarizing plate) 10 is arranged such that the birefringent layers 12 and 13 are positioned between the polarizer 11 and the liquid crystal cell 20. The polarizing plate 10′ is any appropriate polarizing plate. The polarizing plates 10 and 10′ are typically arranged such that absorption axes of the respective polarizers are perpendicular to each other. As shown in FIG. 9, the elliptically polarizing plate 10 of the present invention is preferably arranged on a visual side (upper side) in the liquid crystal display apparatus (liquid crystal panel) of the present invention. The liquid crystal cell 20 includes: a pair of glass substrates 21 and 21′; and a liquid crystal layer 22 as a display medium arranged between the substrates. One substrate (active matrix substrate) 21′ is provided with: a switching element (TFT, in general) for controlling electrooptic characteristics of liquid crystal; and a scanning line for providing a gate signal to the active element and a signal line for providing a source signal thereto (the element and the lines not shown). The other glass substrate (color filter substrate) 21 is provided with color filters (not shown). The color filters may be provided in the active matrix substrate 21′ as well. A space (cell gap) between the substrates 21 and 21′ is controlled by a spacer (not shown). An aligned film (not shown) formed of, for example, polyimide is provided on a side of each of the substrates 21 and 21′ in contact with the liquid crystal layer 22.

Hereinafter, the present invention will be more specifically described by way of examples. However, the present invention is not limited to the examples. Methods of measuring characteristics in the examples are as described below.

### (1) Measurement of Retardation

Refractive indices nx, ny, and nz of a sample film were measured with an automatic birefringence analyzer (Automatic birefringence analyzer KOBRA-31PR manufactured by Oji Scientific Instruments), and an in-plane retardation And a thickness direction retardation Rth were calculated. A measurement temperature was 23° C., and a measurement wavelength was 590 nm.

### (2) Measurement of Thickness

The thickness of the first birefringent layer was measured through interference thickness measurement by using MCPD-2000, manufactured by Otsuka Electronics Co., Ltd. The thickness of each of other various films was measured with a dial gauge.

### (3) Measurement of Transmittance

The same elliptically polarizing plates obtained in Example 1 were attached together. The transmittance of the attached sample was measured with DOT-3 (trade name, manufactured by Murakami Color Research Laboratory).

### (4) Measurement of Contrast Ratio

The same elliptically polarizing plates were superimposed, and were irradiated with backlight. A white image (absorption axes of polarizers are in parallel with each other) and a black image (absorption axes of polarizers are perpendicular to each other) were displayed, and were scanned from 45° to 135° with respect to the absorption axis of the polarizer on the visual side, and from −60° to 60° with respect to the normal by using “EZ Contrast 160D” (trade name, manufactured by ELDIM SA). A contrast ratio “YW/YB” in an oblique direction was calculated from a Y value (YW) of the white image and a Y value (YB) of the black image.

### EXAMPLE 1

### I. Preparation of Elliptically Polarizing Plate as Shown in FIG. 1

I-a. Alignment Treatment for Substrate (Preparation of Aligned substrate)

Substates were subjected to alignment treatment, to thereby prepare aligned substrates.

Substrates (1) to (6): A surface of a polyethylene terephthalate (PET) film (thickness of 50 μm) was subjected to rubbing at a rubbing angle shown in Table 1 below by using a rubbing cloth, to thereby form each of aligned substrates.

TABLE 1

| Substrate | Rubbing angle (angle α) |
|---|---|
| (1) | 13° |
| (2) | −13° |
| (3) | 23° |
| (4) | −23° |
| (5) | 33° |
| (6) | −33° |

I-b. Preparation of First Birefringent Layer (First Birefringent Layer Formed on Substrate)

10 g of polymerizable liquid crystal (Paliocolor LC242, trade name; manufactured by BASF Aktiengesellschaft) exhibiting a nematic liquid crystal phase, and 3 g of a photopolymerization initiator (IRGACURE 907, trade name; manufactured by Ciba Specialty Chemicals) for the polymerizable liquid crystal compound were dissolved in 40 g of toluene, to thereby prepare a application liquid. The liquid crystal composition was applied onto each of the aligned substrates (1) to (6) prepared as described above by using a bar coater, and the whole was heated and dried at 90° C. for 2 minutes, to thereby align the liquid crystal. The thus formed liquid crystal layer was irradiated with light of 1 mJ/cm² by using a metal halide lamp, and the liquid crystal layer was cured, to thereby form each of first birefringent layers.

The thickness and retardation of each of the first birefringent layers were adjusted by changing an application amount of the application liquid. Table 2 shows the thickness (μm) and in-plane retardation (nm) of each of the first birefringent layers formed.

TABLE 2

| | | | | In-plane |
|---|---|---|---|---|
| Substrate + | | | Thickness of | retardation |
| first | | Rubbing | first | value of first |
| birefringent | | angle | birefringent | birefringent |
| layer | Substrate | (angle α) | layer (μm) | layer (nm) |
| (1a) | (1) | 13° | 2.4 | 240 |
| (2a) | (2) | −13° | 2.4 | 240 |
| (3a) | (3) | 23° | 2.2 | 180 |
| (3b) | (3) | 23° | 2.4 | 240 |
| (3c) | (3) | 23° | 2.6 | 300 |
| (4a) | (4) | −23° | 2.2 | 180 |
| (4b) | (4) | −23° | 2.4 | 240 |
| (4c) | (4) | −23° | 2.6 | 300 |
| (5a) | (5) | 33° | 2.4 | 240 |
| (6a) | (6) | −33° | 2.4 | 240 |

I-c. Preparation of Second Birefringent Layer

A polycarbonate film (thickness of 60 μm) or a norbornene-based film (Arton, trade name; manufactured by JSR Corporation; thickness of 60 μm) was uniaxially stretched at a predetermined temperature, to thereby prepare each of second birefringent layers. Table 3 shows the type of film used (polycarbonate film is represented by PC, and norbornene film is represented by NB), the stretching conditions (such as a stretching direction), the angle β (angle of a slow axis of the film with respect to a longitudinal direction), and the retardation value to be obtained.

TABLE 3

| | Stretching conditions | | | Birefringent layer | | |
|---|---|---|---|---|---|---|
| Film | | Temp- | | Angle | | |
| No. | Direction | erature | Ratio | β | Thickness | Retardation |
| (a1) | Lateral | 150° C. | 1.2 | 90° | 50 μm | 60 nm |
| PC | | | times | | | |
| (a2) | Lateral | 150° C. | 1.3 | 90° | 50 μm | 90 nm |
| PC | | | times | | | |
| (a3) | Lateral | 150° C. | 1.45 | 90° | 50 μm | 120 nm |
| PC | | | times | | | |
| (a4) | Lateral | 150° C. | 1.6 | 90° | 50 μm | 150 nm |
| PC | | | times | | | |
| (a5) | Lateral | 150° C. | 2.0 | 90° | 50 μm | 180 nm |
| PC | | | times | | | |
| (a6) | Longitudinal | 140° C. | 1.05 | 0° | 55 μm | 140 nm |
| PC | | | times | | | |
| (a7) | Longitudinal | 170° C. | 1.4 | 0° | 65 μm | 140 nm |
| NB | | | times | | | |
| (b1) | Longitudinal | 140° C. | 1.1 | 0° | 55 μm | 270 nm |
| PC | | | times | | | |
| (b2) | Longitudinal | 170° C. | 1.9 | 0° | 65 μm | 270 nm |
| NB | | | times | | | |

I-d. Preparation of Second Birefringent Layer (II)

Polymerizable liquid crystal (Paliocolor LC242, trade name; manufactured by BASF Aktiengesellschaft) exhibiting a nematic liquid crystal phase, a chiral agent (Paliocolor LC756, trade name; manufactured by BASF Aktiengesellschaft), and a photopolymerization initiator (IRGACURE 907, trade name; manufactured by Ciba Specialty Chemicals) for the polymerizable liquid crystal compound in respective amounts shown in Table 4 were dissolved in 40 g of toluene, to thereby prepare a liquid crystal application liquid. Meanwhile, a polyethylene terephthalate resin was extruded, laterally stretched at 140° C., and recrystallized at 200° C. to form a film, which was used as a substrate. The liquid crystal application liquid was applied onto the substrate film by using a bar coater, and the whole was heated and dried at 90° C. for 2 minutes, to thereby align the liquid crystal. The thus formed liquid crystal layer was irradiated with light of 1 mJ/cm² by using a metal halide lamp, and the liquid crystal layer was cured, to thereby form each of films for second birefringent layers c1 to c3. Table 4 also shows the angle β of the slow axis of each of the films c1 to c3 with respect to the absorption axis of the polarizer. The films c1 to c3 each had a in-plane retardation of 120 nm and a thickness of 1.2 μm

TABLE 4

| Film | Polymerizable | Chiral | Polymerization | |
|---|---|---|---|---|
| No. | liquid crystal | agent | initiator (unit: g) | Angle β |
| c1 | 9.9964 | 0.0036 | 3 | 85° |
| c2 | 9.9930 | 0.0070 | 3 | 80° |
| c3 | 9.9899 | 0.0100 | 3 | 75° |

I-e. Production of Elliptically Polarizing Plate

A polyvinyl alcohol film was colored in an aqueous solution containing iodine, and was uniaxially stretched to a 6 times length between rolls having different speed ratios in an aqueous solution containing boric acid, to thereby obtain a polarizer.

The polarizer, a transparent protective film (TAC film, thickness of 40 μm), and the first birefringent layer formed on the substrate were delivered in a direction of an arrow as shown in a schematic diagram of FIG. 5, and were attached together by using a moisture-curable adhesive containing isocyanate (trade name, M-631N, manufactured by Mitsui Takeda Chemicals, Inc.) with the respective longitudinal directions in the same direction. The adhesive had a thickness of 5 μm. Next, the substrate was peeled off from the obtained laminate (laminate including the polarizer, the transparent protective film (protective layer), the first birefringent layer, and the substrate), to thereby obtain a laminate including the polarizer, the transparent protective film (protective layer), and the first birefringent layer.

Then, as shown in a schematic diagram of FIG. 6, continuous second birefringent layers (a1) to (a7) and (b1) and (b2) were prepared, and both of the continuous second birefringent layers and the laminate obtained above were delivered in a direction of an arrow, and were attached together by using a moisture-curable adhesive containing isocyanate (trade name, M-631N, manufactured by Mitsui Takeda Chemicals, Inc.) with the respective longitudinal directions in the same direction.

Meanwhile, as shown in a schematic diagram of FIG. 7A, second birefringent layers (c1) to (c3) each formed on a continuous substrate were prepared, and both of the second birefringent layers and the laminate obtained above were delivered in a direction of an arrow, and were attached together by using a moisture-curable adhesive containing isocyanate (trade name, M-631N, manufactured by Mitsui Takeda Chemicals, Inc.) with the respective longitudinal directions in the same direction. Finally, as shown in FIG. 7B, the substrate was peeled off from the attached laminate. Further, a transparent protective film (TAC: 40 μm) was attached to the opposite side of the polarizer.

As described above and shown in Table 5, the elliptically polarizing plates A01 to A21 were obtained.

TABLE 5

| | First birefringent | | | | |
|---|---|---|---|---|---|
| | layer | | Second | | |
| Elliptically | | In-plane | birefringent | Trans- | Total |
| polarizing | | retardation | layer | mittance | thickness |
| plate | Angle α | value (nm) | Angle β | (%) | (μm) |
| A01 | +23° | 180 | a3(90°) | 0.10 | 170 |
| A02 | −23° | 180 | a3(90°) | 0.10 | 170 |
| A03 | +23° | 240 | a3(90°) | 0.05 | 170 |
| A04 | −23° | 240 | a3(90°) | 0.05 | 170 |
| A05 | +23° | 300 | a3(90°) | 0.08 | 171 |
| A06 | −23° | 300 | a3(90°) | 0.08 | 171 |
| A07 | +23° | 240 | a2(90°) | 0.09 | 170 |
| A08 | −23° | 240 | a2(90°) | 0.09 | 170 |
| A09 | +23° | 240 | a4(90°) | 0.10 | 170 |
| A10 | −23° | 240 | a4(90°) | 0.10 | 170 |
| A11 | +13° | 240 | a3(90°) | 0.13 | 170 |
| A12 | −13° | 240 | a3(90°) | 0.13 | 170 |
| A13 | +33° | 240 | a3(90°) | 0.14 | 170 |
| A14 | −33° | 240 | a3(90°) | 0.14 | 170 |
| A15 | −23° | 240 | a3(90°) | 0.06 | 170 |
| A16 | −33° | 240 | a3(90°) | 0.06 | 170 |
| A17 | +23° | 240 | a3(90°) | 0.07 | 170 |
| A18 | −23° | 240 | a3(90°) | 0.07 | 170 |
| A19 | +23° | 240 | c1(85°) | 0.07 | 122 |
| A20 | +23° | 240 | c2(80°) | 0.07 | 122 |
| A21 | +13° | 240 | c3(75°) | 0.07 | 122 |

### EXAMPLE 2

The elliptically polarizing plates A01 were superimposed to measure a contrast ratio. Table 1 reveals that the elliptically polarizing plate had a relationship represented by an expression β=2α+44°. The elliptically polarizing plate had the minimum angle of 40° and maximum angle of 50° for contrast 10 in all directions, and a difference between the maximum and minimum angles of 10°. The minimum angle of 40° for contrast 10 in all directions was at a preferred level in practical use. Further, the difference between the maximum and minimum angles of 10° was so small that the elliptically polarizing plate had balanced visual characteristics, and thus the difference was also at a verypreferred level inpractical use.

### EXAMPLE 3

The elliptically polarizing plates A21 were superimposed to measure a contrast ratio. Table 1 reveals that the elliptically polarizing plate had a relationship represented by an expression β=2α+49°. The elliptically polarizing plate had the minimum angle of 40° and maximum angle of 60° for contrast 10 in all directions, and a difference between the maximum and minimum angles of 20°. The minimum angle of 40° for contrast 10 in all directions was at a preferred level in practical use.

### COMPARATIVE EXAMPLE 1

The elliptically polarizing plates A11 were superimposed to measure a contrast ratio. Table 1 reveals that the elliptically polarizing plate had a relationship represented by an expression β=2α+64°. The elliptically polarizing plate had the minimum angle of 30° and maximum angle of 50° for contrast 10 in all directions, and a difference between the maximum and minimum angles of 20°. The minimum angle of 30° for contrast 10 in all directions was not at an appropriate level in practical use.

### COMPARATIVE EXAMPLE 2

The elliptically polarizing plates A13 were superimposed to measure a contrast ratio. Table 1 reveals that the elliptically polarizing plate had a relationship represented by an expression β=2α+24°. The elliptically polarizing plate had the minimum angle of 30° and maximum angle of 50° for contrast 10 in all directions, and a difference between the maximum and minimum angles of 20°. The minimum angle of 30° for contrast 10 in all directions was not at an appropriate level in practical use.

Example 1 revealed that the first birefringent layer formed on the continuous substrate subjected to the alignment treatment to form a predetermined angle with respect to a longitudinal direction, the continuous transparent protective film, the continuous polarizing film (polarizer), and the second birefringent layer were consecutively attached by roll-to-roll with the respective longitudinal directions in the same direction through the production method of the present invention, to thereby provide an elliptically polarizing plate at excellent production efficiency.

Further, the results of Examples 2 and 3 and Comparative Examples 1 and 2 reveal that the present invention allows optimization of the angle α between the absorption axis of the polarizer and the slow axis of the first birefringent layer, and the angle β between the absorption axis of the polarizer and the slow axis of the second birefringent layer into a relationship represented by an expression 2α+40°<β<2α+50°, to thereby provide the minimum angle of 40° for contrast 10 in all directions for the elliptically polarizing plate of the present invention and ensure a preferred level in practical use. In particular, the difference between the maximum and minimum angles was reduced to 10° in Example 2, which provided highly balanced visual characteristics and was also at a very preferred level in practical use. In contrast, the results of Comparative Examples in which the angles α and β did not satisfy the above relationship reveal that the elliptically polarizing plates of Comparative Examples each had the minimum angle of 30° for contrast 10 in all directions, which was not at an appropriate level in practical use.

### INDUSTRIAL APPLICABILITY

The elliptically polarizing plate obtained through the production method of the present invention may suitably be used for various image display apparatuses (such as a liquid crystal display apparatus and a self-luminous display apparatus).

1. A method of producing an elliptically polarizing plate comprising the steps of:
forming a first birefringent layer on a surface of a transparent protective film (T);
laminating a polarizer on a surface of the transparent protective film (T); and
forming a second birefringent layer by laminating a polymer film on a surface of the first birefringent layer, wherein:
the first birefringent layer and the polarizer are arranged on opposite sides of the transparent protective film (T);
the step of forming a first birefringent layer comprises the steps of:
applying an application liquid containing a liquid crystal material to a substrate subjected to alignment treatment;
forming a first birefringent layer on the substrate by treating the applied liquid crystal material at a temperature at which the liquid crystal material exhibits a liquid crystal phase; and
transferring the first birefringent layer formed on the substrate to a surface of the transparent protective film (T); and
angles α and β satisfy a relationship represented by the following expression (1):
2α+40°<β<2α+50° (1)
where, α represents an angle formed between a slow axis of the polarizer and a slow axis of the first birefringent layer, and β represents an angle formed between the absorption axis of the polarizer and a slow axis of the second birefringent layer.

2. The method according to claim 1, wherein:
the polarizer, the transparent protective film (T), the first birefringent layer formed on the substrate, and the polymer film used for forming the second birefringent layer are each a continuous film;
long sides of the polarizer, the transparent protective film (T), and the first birefringent layer formed on the substrate are continuously attached together to form a laminate including the polarizer, the transparent protective film (T), the first birefringent layer, and the substrate in the stated order;
the substrate is peeled off from the laminate; and
long sides of the laminate having the substrate peeled off and the polymer film used for forming the second birefringent layer are continuously attached together.

3. The method according to claim 1, wherein the liquid crystal material comprises at least one of a liquid crystal monomer and a liquid crystal polymer.

4. The method according to claim 1, wherein the first birefringent layer comprises a λ/2 plate.

5. The method according to claim 1, wherein the second birefringent layer comprises a λ/4 plate.

6. The method according to claim 1, wherein the substrate comprises a polyethylene terephthalate film.

7. The method according to claim 1, wherein the polymer film comprises a stretched film.

8. An elliptically polarizing plate, which is produced through the method according to claim 1.

9. An image display apparatus, which comprises the elliptically polarizing plate according to claim 8.

10. The method according to claim 2, wherein the liquid crystal material comprises at least one of a liquid crystal monomer and a liquid crystal polymer.

11. The method according to claim 2, wherein the first birefringent layer comprises a λ/2 plate.

12. The method according to claim 3, wherein the first birefringent layer comprises a λ/2 plate.

13. The method according to claim 2, wherein the second birefringent layer comprises a λ/4 plate.

14. The method according to claim 3, wherein the second birefringent layer comprises a λ/4 plate.

15. The method according to claim 4, wherein the second birefringent layer comprises a λ/4 plate.

16. The method according to claim 2, wherein the substrate comprises a polyethylene terephthalate film.

17. The method according to claim 3, wherein the substrate comprises a polyethylene terephthalate film.

18. The method according to claim 4, wherein the substrate comprises a polyethylene terephthalate film.

19. The method according to claim 5, wherein the substrate comprises a polyethylene terephthalate film.
